(19) United States
(12) Patent Application Publication
(10) Pub. No.: US 2025/0330015 A1
(43) Pub. Date: Oct. 23, 2025

(54) SYSTEMS AND METHODS FOR A CONFIGURABLE CHARGING DEVICE

(71) Applicant: MILWAUKEE ELECTRIC TOOL CORPORATION, Brookfield, WI (US)

(72) Inventor: Nathan J. Gustafson, Milwaukee, WI (US)

(21) Appl. No.: 18/870,346

(22) PCT Filed: May 31, 2023
(86) PCT No.: PCT/US2023/024025

§ 371 Date: Nov. 27, 2024

Related U.S. Application Data
(60) Provisional application No. 63/347,857, filed on Jun. 1, 2022.

(51) Int. Cl. H02J 1/14; H02J 7/00

(52) U.S. Cl. CPC H02J 1/14; H02J 7/0063

(57) ABSTRACT

Devices described herein include a battery-powered output device having a number of output ports, a power source, and a controller. The controller is configured to receive a user input indicating a desired configuration of the output ports. The controller is further configured to configure the output ports based on the received user input and a total power budget of the battery-powered power output device.

### RELATED APPLICATIONS

This application claims the benefit of U.S. Provisional Patent Application No. 63/347,857, filed Jun. 1, 2022, the entire content of which is hereby incorporated by reference.

### FIELD

This disclosure relates to a charging device.

### SUMMARY

Battery power output devices described herein include a battery-powered output device having a number of output ports, a power source, and a controller. The controller is configured to receive a user input indicating a desired configuration of the output ports. The controller is further configured to configure the output ports based on the received user input and a total power budget of the battery-powered power output device.

In one aspect, the received user input specifies a desired output power for each of the output ports.

In another aspect, a power matrix circuit is coupled to the controller, wherein the controller is further configured to control the power matrix circuit to provide the desired output power to each of the plurality of output ports.

In another aspect, the battery-powered output device further comprises a port manager configured to receive one or more device parameters associated with one or more external devices coupled to the output ports.

In another aspect, the controller is configured to configure the output ports based on the received device parameters associated with the one or more external devices coupled to the output ports.

In another aspect, the received user input includes one or more device priority profiles identifying an output power priority for each of the plurality of output ports based on the one or more device parameters associated with the one or more external devices coupled to the output ports.

In another aspect, the output ports are selected from a group consisting of USB-A ports and USB-C ports.

In another aspect, the power source is a rechargeable power tool battery pack.

In one embodiment, a process for controlling multi-output USB hub devices is described. The process includes receiving, at a controller of the USB hub device, a user input indicating a desired configuration of the one or more output ports of the USB hub device. The process also includes determining a total power budget of the USB hub device and configuring the one or more output ports of the USB hub based on the received user input and the determined total power budget. Configuring the one or more output ports includes controlling an available output power for each of the one or more output ports.

In one aspect, the user input is wirelessly received from an external device.

In another aspect, the user input is received at a user interface of the USB hub device.

In another aspect, the process further includes controlling a power matrix circuit of the USB hub device by the controller, wherein the power matrix circuit is configured to control an amount of available power for each of the one or more output ports is based on an instruction from the controller.

In another aspect, the process further includes receiving one or more device parameters from one or more external devices coupled to each of the one or more output ports.

In another aspect, the one or more received device parameters include one or more of a charging voltage of the one or more external device, an optimal charging power of the one or more external device, and an identifier of the one or more external devices.

In another aspect, the received user input includes a device priority profile, wherein the device priority profile prioritizes devices connected to the one or more output ports based on the one or more received device parameters.

In another aspect, the one or more output ports are controlled based on the determined total power budget, the received user input, and the one or more received device parameters.

In another aspect, the one or more output ports are selected from a group consisting of USB-A ports and USB-C ports.

In another aspect, the USB hub device is powered by a rechargeable battery pack.

In another embodiment, a modular USB hub is described. The modular USB hub includes a power source, one or more hot-swappable connection ports, and one or more USB power modules. Each of the one or more USB power modules is configured to be connected to the one or more hot-swappable connection ports. Additionally, the one or more USB power modules each include a USB output port. Each of the one or more USB power modules receive power from the power source and has a power rating that controls the output power available at the associated USB output port.

In one aspect, the USB hub further includes a controller configured to derate the output power of each of the one or more USB power modules based on a total power budget of the modular USB hub being exceeded.

Before any embodiments are explained in detail, it is to be understood that the embodiments are not limited in application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the invention will become apparent by consideration of the detailed description and accompanying drawings.

### BRIEF DESCRIPTION OF THE DRAWINGS

FIG. 1 is a block diagram of a modular output hub device, according to some embodiments.

FIG. 2 is flow chart illustrating a process for controlling the hub device of FIG. 1, according to some embodiments.

FIG. 3 is a block diagram illustrating the hub device of FIG. 1 in a first configuration, according to some embodiments.

FIG. 4 is a block diagram illustrating the hub device of FIG. 1 in a second configuration, according to some embodiments.

FIG. 5 is a block diagram of a hub device, according to some embodiments.

FIG. 6 is a flow chart illustrating a process for controlling the hub device of FIG. 5, according to some embodiments.

FIG. 7 is a block diagram illustrating the hub device of FIG. 5 in a first configuration, according to some embodiments.

FIG. 8 is a block diagram illustrating the hub device of FIG. 5 in a second configuration, according to some embodiments.

FIG. 9 is a block diagram of a modular hub device in a first modular arrangement, according to some embodiments.

FIG. 10 is a block diagram of the modular hub device of FIG. 9 in a second modular arrangement, according to some embodiments.

### DETAILED DESCRIPTION

Charging devices for various personal electronic devices, such as laptops, smartphones, tablet computers, and the like, generally charge via a universal serial bus (“USB”) port, such as USB-A or USB-C (i.e., USB 2.0). Different types of devices may be coupled to the charging devices at any given time, of which some or all may have different charging requirements and/or characteristics. The following embodiments provide for a charging device that is able to be configured to vary the output of multiple output ports to optimize the charging power provided to various ports.

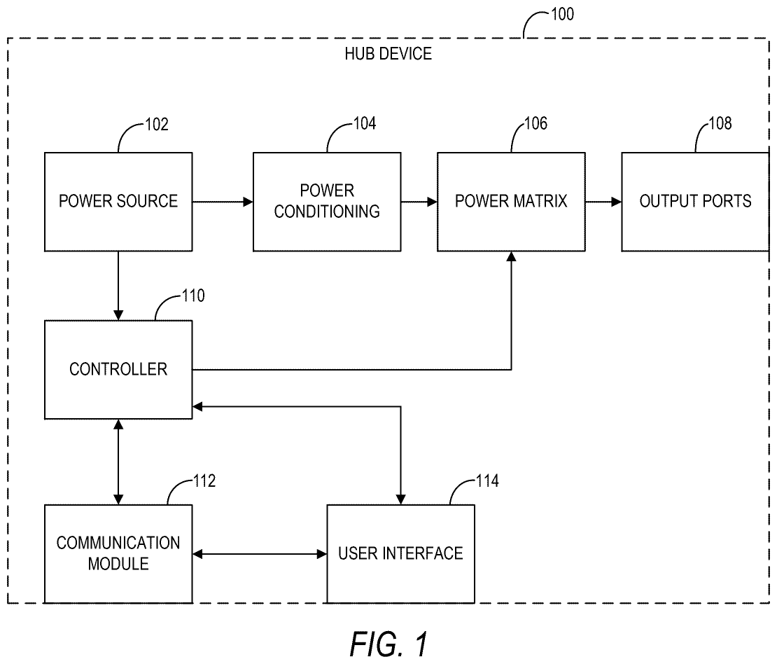

FIG. 1 is a block diagram of a hub device 100, according to one embodiment. The hub device 100 includes a power source 102, a power conditioning circuit 104, a power matrix circuit 106, a number of output ports 108, a controller 110, a communication module 112, and a user interface 114. In some embodiments, the power source 102 is a rechargeable power source, such as a rechargeable battery pack. In some examples, the power source 102 is a lithium-ion rechargeable battery pack. The power source 102 may be a rechargeable power tool battery pack which may be removable from the hub device 100 via a battery pack interface. For example, the power source 102 may be an 18V rechargeable battery pack, a 24V rechargeable battery pack, a 12V rechargeable battery pack, or the like. It is understood that other battery voltages are contemplated as required for a given application. In other examples, the power source 102 is an integral power source, such as integral rechargeable battery, (e.g., a lithium-ion battery). An integral rechargeable battery may have similar voltages to an external battery pack, such as mentioned above.

The power conditioning circuit 104 is configured to condition the power provided by the power source 102. For example, the power conditioning circuit 104 may convert the voltage output of the power source 102 to a lower voltage for use by the output ports 108. For example, the power conditioning circuit 104 may convert an output of the power source 102 to a lower voltage, such as 5 VDC, 3.3 VDC, or the like. The power conditioning circuit 104 may further be configured to perform other conditioning operations, such as filtering, current limiting, surge protection, sag protection, and the like. In some embodiments, the power conditioning circuit 104 is integral to the power source 102.

The power conditioning circuit 104 outputs conditioned power to the power matrix circuit 106. The power matrix circuit 106 may be configured to further modify the conditioned power for each of the output ports 108. In one example, the power matrix circuit 106 includes a group of voltage converters configured to generate an output voltage for each of the respective output ports 108, as will be described in more detail below. For example, the power matrix circuit 106 may be configurable to combine output power from one or more of the voltage converters to control a nominal output power at different output ports 108.

The output ports 108 may be various types of output ports configured to provide power to one or more external devices. In one exemplary embodiment, the output ports 108 include a number of universal serial bus (“USB”) ports. For example, the output ports 108 may include a combination of USB-A and USB-C output ports. For brevity, the outputs ports 108 are described generally as being USB ports. However, other output port types, such as firewire, micro-USB, or other applicable power output port types are also contemplated as required for a given application. As will be described in more detail below, each of the number of output ports 108 may have a respective power converter within the power matrix circuit 106 for controlling the output power provided to the respective output port 108.

The controller 110 may be coupled to, and in communication with, multiple components within the hub device 100. For example, the controller 110 may be in communication with the power source 102, the power matrix circuit 106, the communication module 112, and/or the user interface 114. However, the controller 110 may be in communication with more or fewer components as required for a given application. In some embodiments, the controller 110 includes a number of electrical and electronic components that provide power, operational control, and protection to the components and modules within the hub device 100. For example, the controller 110 may include, among other things, a processing unit (e.g., a microprocessor, a microcontroller, an electronic processor, an electronic controller, or another suitable programmable device), a memory, input units, and output units. The processing unit may include, among other things, a control unit, an arithmetic logic unit (“ALU”), and a plurality of registers, and may be implemented using a known computer architecture, such as a modified Harvard architecture, a von Neumann architecture, etc. The controller 110 may be coupled to the various components within the hub device 100 by one or more control and/or data buses. The use of one or more control and/or data buses for the interconnection between and communication among the various modules and components would be known to a person skilled in the art in view of the invention described herein.

The communication module 112 may be configured to communicate with one or more external devices to provide a remote communication path to the controller 110. In one embodiment, the communication module 112 includes a transceiver configured to send and receive data using one or more wireless communication protocols. Example wireless communication protocols may include Bluetooth, Bluetooth Low Energy (“BLE”), LoRa, Wi-Fi, Wi-Max, Zigbee, Z-Wave, cellular (e.g., 4G, 5G, LTE), Near Field Communication (“NFC”), RF, or other applicable wireless communication protocol. In other embodiments, the communication module 112 may facilitate one or more wired communication protocols, such as USB, Firewire, serial (e.g., RS-232), CAN Bus, or other applicable wired communication protocol. In some examples, the communication module 112 may be configured to communicate with one or more external devices using a combination of wireless communication protocols and wired communication protocols. The communication module 112 may be controlled via the controller 110, and as such may transmit data from, and provide received data to, the controller 110 as applicable. The communication module 112 may further allow for a user to provide instructions to the hub device 100, such as via the controller 110, using an external device, such as a smartphone, a computer, a tablet computer, a dedicated external device, etc. For example, the user may provide instructions via an external device (such as an external device running one or more software applications for interfacing with the hub device 100) to control a configuration of the hub device 100, as will be described in more detail below. In some embodiments, the external devices may be configured to communicate with the communication module 112 over Bluetooth using the ONE-KEY® application from Milwaukee Electric Tool Corporation.

The user interface 114 may include one or more input devices configured to allow a user to interact directly with the hub device 100. For example, the user interface 114 may include a touchscreen configured to allow a user to provide one or more inputs to configure the hub device 100, as will be described in more detail below. The user interface 114 may further include a display to allow a user to view one or more parameters associated with the hub device 100. The parameters may be provided to the user interface 114 by the controller 110.

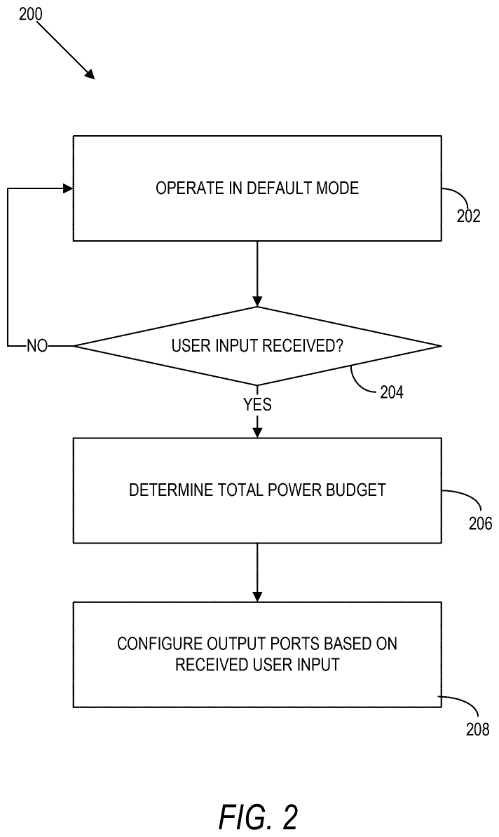

Turning now to FIG. 2, a process 200 for controlling a hub device, such as hub device 100, is described according to some embodiments. At process block 202, the hub device 100 operates in a set mode. When operating in the set mode, the hub device 100 controls the power output at each of the output ports 108 based on one or more control schemes. In one embodiment, the controller 110 controls the power matrix circuit 106 to output the same power to each of the output ports 108. In other examples, the controller 110 may control the power matrix circuit 106 to output power to each of the output ports 108 based on a previously set control profile. The ability to modify the power provided to each of the output ports 108 where some devices coupled to the output ports 108 may require more power to efficiently charge or operate based on the type of device. Where the total power output is limited, simply setting each output port to have the same amount of available output power may reduce the efficiency of the hub device 100 for charging certain devices. However, dedicating certain output ports 108 to be dedicated high power output ports reduces the flexibility of the hub device 100 generally. Thus, as described below, the hub device 100 is configurable to allow for optimized power output schemes to be achieved.

At process block 204, the controller 110 determines whether a user input has been received. The user input may be received via the user interface 114 and/or from an external device via the communication module 112. The user input may include instructions to modify the available output power at one or more of the output ports 108. In some embodiments, the modifications available to the user are limited based on a total amount of available power, a rated power limit for each output port 108, and/or other restrictions as required for a given application. In response to determining that no user input was received, the hub device 100 operates in the set mode at 202. In response to determining that a user input was received, the controller 110 determines a total power budget for the hub device 100 at process block 206. In some embodiments, the total power budget is based on a condition of the power source 102. For example, the total power budget may be based on a total power rating of the power source 102. In other embodiments, the total power budget may be determined based on one or more other characteristics of the power source 102, such as a state of charge of the power source 102, a voltage of the power source 102, a current rating of the power source 102, or other parameter as required for a given application. In other embodiments, the total power budget may be based on a default rating of the hub device 100. For example, the total power budget may be 200 W. However, total power budgets of more than 200 W or less than 200 W are also contemplated (e.g., 100 W to 1000 W).

At process block 208, the controller 110 configures one or more of the output ports 108 based on the received user input. As described herein, the output ports 108 may be configured to adjust the amount of available output power provided to each output port 108. In some embodiments, the output ports 108 are configured to adjust the amount of available output power provided to each output port 108 within the limits of the total power budget. Upon configuring the output ports 108 based on the received user input at process block 208, the default hub resumes operation in the set mode at process block 202 with the updated output port 108 configurations based on the received user input.

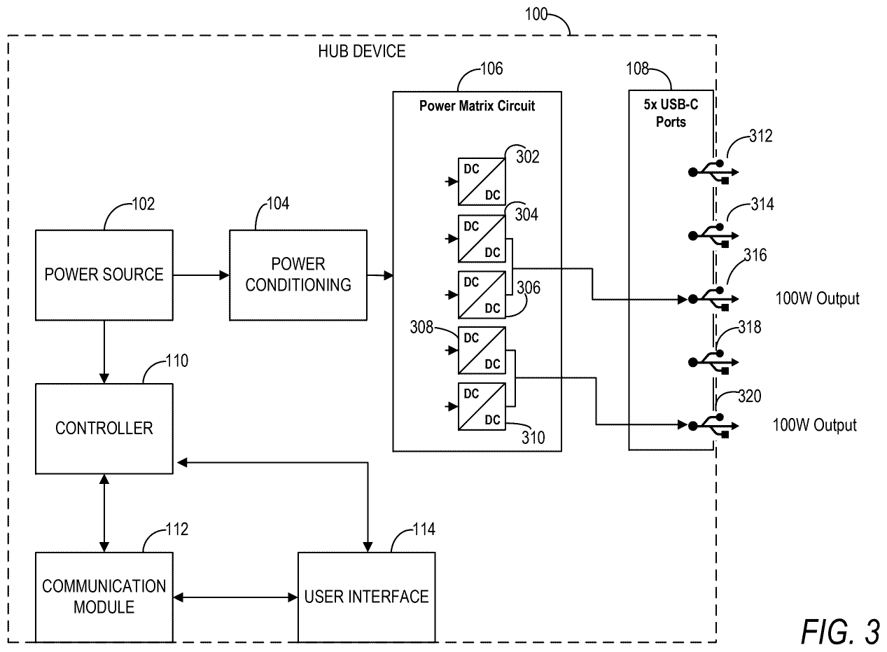

Turning now to FIG. 3, an example of the hub device 100 with a first output port configuration is shown, according to some embodiments. The first configuration of the output ports 108 may be set using the process 200 described above. As shown in FIG. 3, the power matrix circuit 106 includes five voltage converters 302, 304, 306, 308, 310 and the output ports 108 include five separate output ports 312, 314, 316, 318, 320 (shown as USB output ports). The converters 302-310 may be configured to provide power to the one or more output ports 312-320. In some embodiments, one or more of the voltage converters 302-310 are bidirectional voltage converters and can receive power for recharging the power source 102.

As shown in FIG. 3, the hub device 100 is configured such that output ports 316 and 320 were configured to have an output of 100 W each. For example, higher power devices, such as laptop computers, may be coupled to the output ports 216 and 220. In order to obtain 100 W output at the output ports 316 and 320, the controller 110 controls the power matrix circuit 106 such that voltage converters 304 and 306 are combined to provide 100 W of available power to the output port 316. For example, voltage converters 304 and 306 may each have a nominal power rating of 50 W, such that their combined power rating is 100 W. Similarly, the controller 110 may configure the power matrix circuit 106 to combine the output of voltage converters 308 and 310 to provide 100 W of available power to the output port 320. While not shown, the power matrix circuit 106 may include one or more switches (e.g., relays, solid state switches, etc.) for combining the output from various voltage converters 302-310 to provide the desired power level to the output ports 312-320.

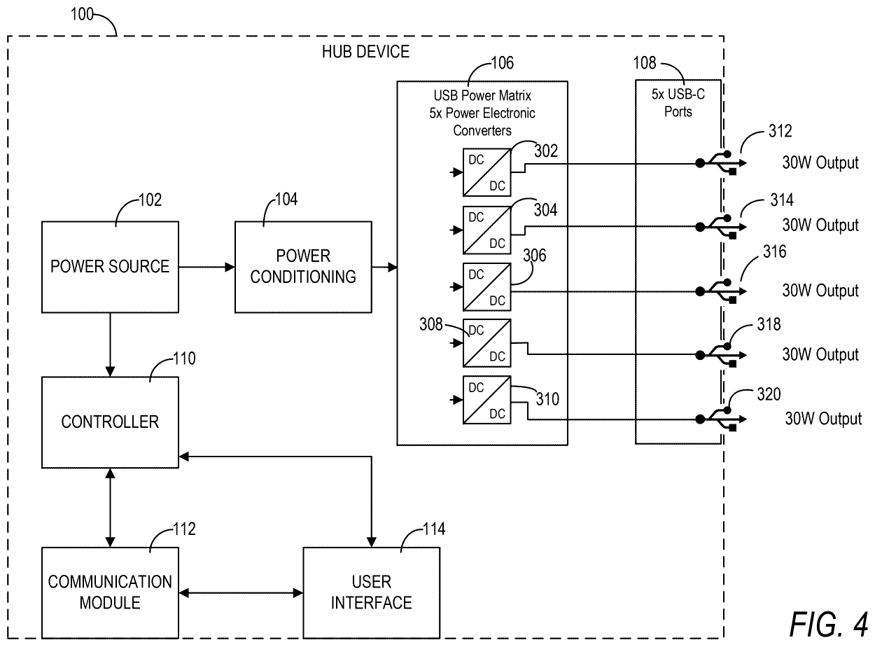

Turning now to FIG. 4, an example of the hub device 100 with a second output port configuration is shown, according to some embodiments. In the second configuration, the hub device 100 is configured such that each of the output ports 312-320 each have a nominal output of 30 W. This may be a desired configuration where multiple low-power consumption devices (e.g., smartphones, wearable devices, headphones, etc.) may be coupled to the hub device. In the second output port configuration, each of the voltage converters 302-310 are provide power individually to each of the output ports 312-320, as shown in FIG. 4.

While FIGS. 3 and 4 show two possible output port configurations, it is contemplated that various other output port configurations are possible, as required for a given application. In some examples, the total power budget is known, and the user may configure the output ports 312-320 to allocate the total power budget as desired.

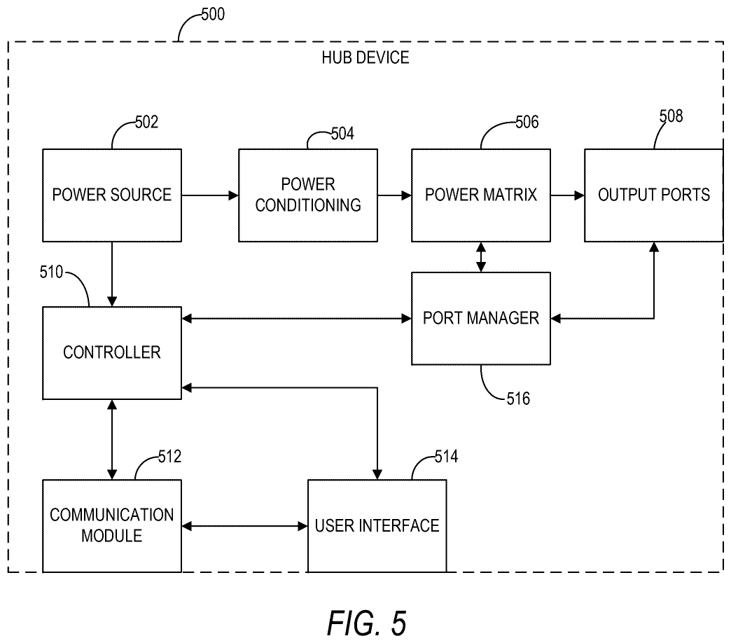

Turning now to FIG. 5, an alternative hub device 500 is shown, according to some embodiments. The hub device 500 includes a power source 502, a power conditioning circuit 504, a power matrix circuit 506, one or more output ports 508, a controller 510, a communication module 512, and a user interface 514. The above components are similar to those described above with respect to the hub device 100 and will not be discussed in detail for the sake of brevity. Any differences in function between those components of the hub device 500 and the hub device 100 will be described below.

The hub device 500 further includes a port manager 516 in communication with the power matrix circuit 506, the controller 510, and the output ports 508. The port manager 516 is configured to detect one or more characteristics of a device coupled to the one or more output ports 508. For example, the port manager 516 may determine parameters, such as power draw, voltage level, device types, etc. In some embodiments, the port manager determines characteristics associated with the devices coupled to the one or more output ports 508 based on data communicated by the external devices using a communication protocol, such as USB Power Delivery (“USB PD”). For example, the external devices connected to the one or more output ports 508 may provide data such as a power rule associated with the device, which may include a required voltage, desired power output, etc. However, the port manager 516 may use other protocols or sensed parameters to determine characteristics of the devices coupled to the output ports 508. The port manager 516 may further determine a charging status of a device coupled to the output ports 508. The charging status may be a status such as “charging,” “charged,” or a charge level.

The port manager 516 may communicate the determined characteristics of the external device connected to the output ports 508 to the controller 510. The controller 510 may be configured to provide the characteristics of the external devices coupled to the output ports 508 to a user via the user interface 514 or to a user device via the communication module 512. The user may then configure the hub device 500 to provide power to the external devices coupled to the output ports 508 based on the characteristics of the coupled devices as will be described in more detail below.

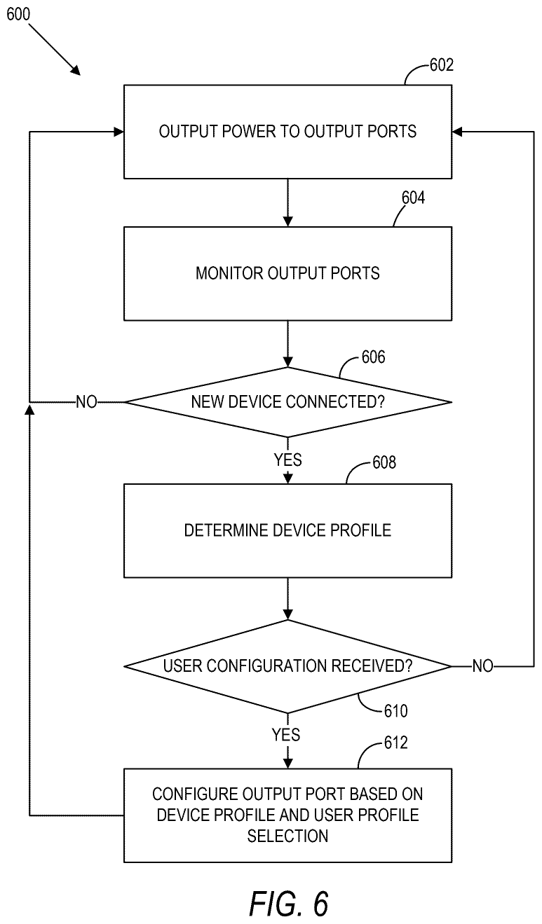

Turning now to FIG. 6, a process 600 for controlling the hub device 500 is described according to some embodiments. At process block 602, the hub device 500 outputs power to the output ports 508. The power provided to the output ports 508 may be based on a default setting or based on a previously provided output configuration, such as described above. At process block 604 the output ports 508 are monitored by the port manager 516. For example, the port manager 516 may monitor the output ports 508 for events such as a new device being connected to the hub device 500, a charging status change of a connected device, etc.

At process block 606, the hub device 500 determines whether a new device has been connected to one of the output ports 508. In some embodiments, the port manager 516 may detect that a new device was coupled to the output ports 508. In response to determining that no new device has been coupled to the output ports 508, the hub device 500 continues to output power to the output ports based on the current output configuration at process block 602. In response to determining that a new device was connected to the output ports 508, a profile of the connected device is determined at process block 608. In one embodiment, the port manager 516 determines the profile of the connected device, as described above. However, in other embodiments, various other components, such as the controller 110 and/or the power matrix circuit 106 may determine the profile of the connected device. In some examples, the determined profile of the connected device may be provided to the user, such as via the user interface 114 and/or transmitted to a user device via the communication module 112. As described above, the profile of the connected device may include a required charging voltage, a required or optimal charging power, a device type, etc.

Upon determining the device profile, the controller 510 determines whether a user configuration was received at process block 610. In response to determining that no user configuration was received, the hub device 500 continues to output power to the output ports based on an existing output profile at process block 602. In response to receiving a user configuration, the controller 510 configures the power matrix circuit 506 to control the output power provided to the output ports 508 based on the device profiles and received user profile selection at process block 612. In some examples, the user profile may include one or more priority schemes for controlling how power is provided to the devices coupled to the output ports 508. For example, one priority scheme may be configured to charge devices requiring the most power first (e.g., laptops, large batteries, etc.). Another priority scheme may prioritize charging the devices requiring the least power first (e.g., phones, tablets, etc.). Other priority schemes may prioritize ensuring all connected devices charge, even where that results in not all devices receiving an optimal power (e.g., as limited by the total power budget), or prioritizing charging at max speed (e.g., providing max power to a first output port 508, even where subsequent output ports 508 may receive no power). Upon configuring the power matrix accordingly, the hub device 500 then outputs power to the output ports according to the current configuration at process block 602.

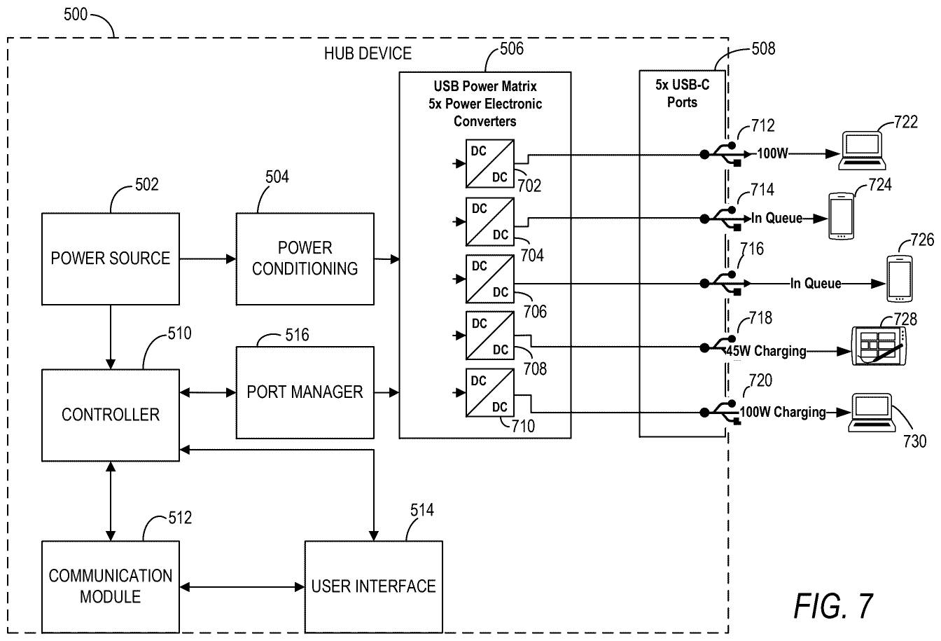

Turning now to FIG. 7, an example of the hub device 500 with a first output port configuration is shown, according to some embodiments. The first configuration of the output ports 508 may be set using the process 600, described above. For example, the first configuration may be based on characteristics of connected devices as well as a received user configuration. As shown in FIG. 7, the power matrix circuit 506 includes five voltage converters 702-710 and the output ports 108 include five separate output ports 712-720. Each of the output ports 712 may have an external device 722-730 connected thereto.

As shown in FIG. 7, the hub device 500 is configured such that the output ports 712, 716 and 720 are prioritized to charge the respective devices 722, 728, 730. For example, the user profile may have prioritized charging devices over 30 W. Accordingly, the output ports 714, 716 are not providing power to the respective connected devices 724, 726 and therefore connected devices 724, 726 are placed in a charging queue until one or more of the devices 722, 728, 730 are finished charging. For example, the hub device 500 may have total power budget of 150 W, and therefore the 245 W of output power shown in FIG. 7 is consuming all of the available power budget. While not shown, upon one or more devices 722, 728, 730 completing their respective charging operations, the power matrix circuit 506 may control the output ports 714, 716 to begin providing power to the devices 724, 726.

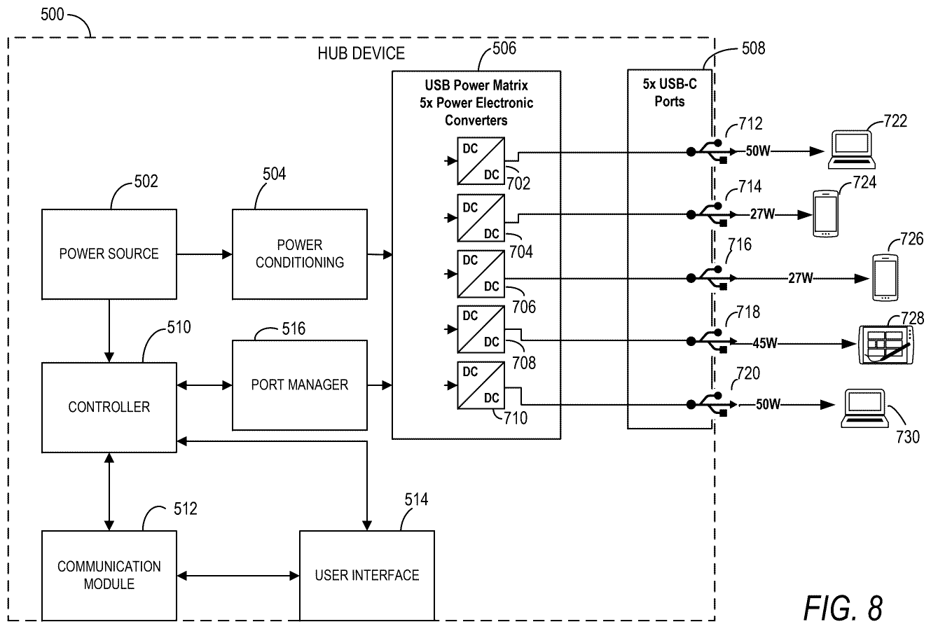

Turning now to FIG. 8, an example of the hub device 500 with a second output port configuration is shown, according to some embodiments. The second configuration of the output ports 508 may be set using the process 600, described above. For example, the second configuration may be based on characteristics of connected devices as well as a received user configuration. As shown in FIG. 8, the power matrix circuit 506 includes five voltage converters 702-710 and the output ports 108 include five separate output ports 712-720. Each of the output ports 712 may have an external device 722-730 connected thereto.

As shown in FIG. 8, the hub device 500 is configured such that the output ports 712-720 are configured to prioritize charging all of the connected devices 722-728 at the same time. Thus, higher power devices, such as devices 722 and 728 may not receive their full optimal charging power (e.g., 100 W). Accordingly, each of the devices 722-728 will be charged simultaneously. The amount of power provided to each may be limited to a maximum amount of power for each port based on the total power budget of the hub device 500. For example, the hub device 500 may have a total budge of 250 W, and therefore each of the output ports may be set to 50 W to ensure each output port 712-720 is able to receive a maximum of 50 W.

While FIGS. 7 and 8 show two possible output port configurations, it is contemplated that various other output port configurations are possible, as required for a given application. For example, the user may prioritize charging lower power devices first, charging higher power devices first until they reach a minimum charge level, etc.

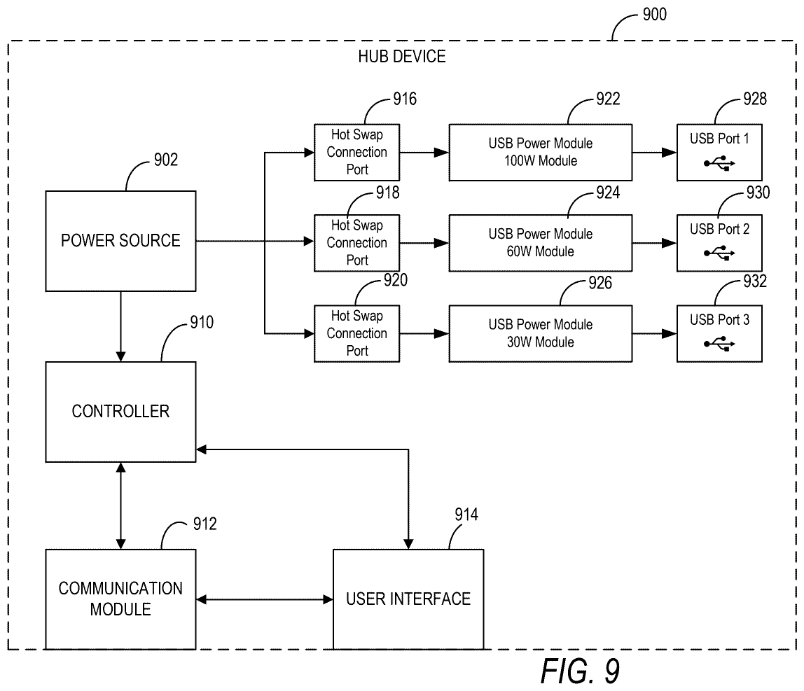

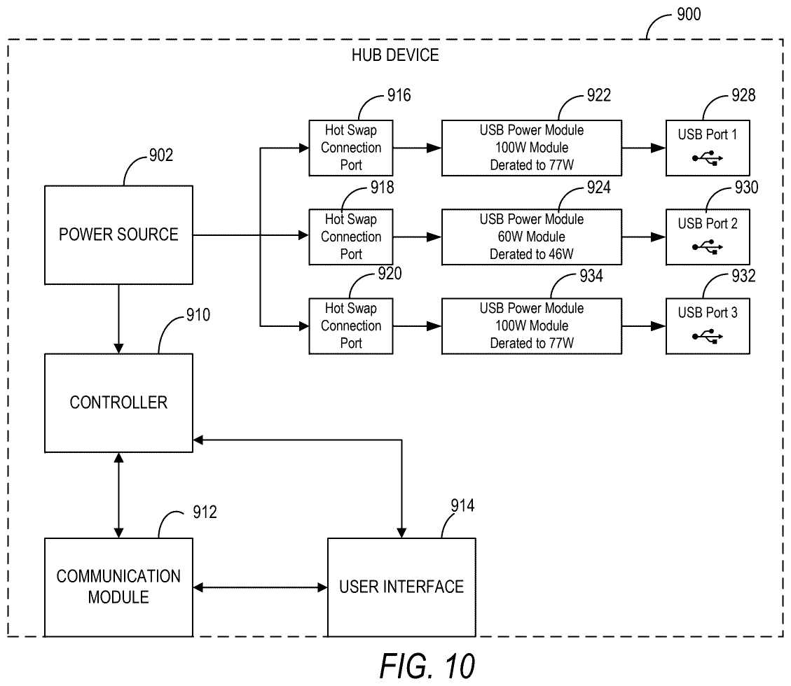

Turning now to FIGS. 9-10, a further embodiment of a hub device 900 is shown according to some embodiments. The hub device 900 includes a power source 902, a controller 910, a communication module 912, and a user interface 914. The power source 902, controller 910, communication module 912, and user interface 914 may generally be similar to the power source 102, controller 110, communication module 912, and user interface 914 described above. The hub device 900 further includes a number of hot swap connection ports 916, 918, 920. Each of the hot swap connection ports 916, 918, 920 are configured to selectively removably receive a USB power module, such as USB power modules 922, 924, 926 shown in FIG. 9. The USB power modules 922, 924, 926 may be individual modules with specific power output ratings that can be coupled to each of the hot swap connection ports 916, 918, 920 to allow for the outputs of the hub device 900 to be manually selected based on the USB power module provided. For example, in the configuration shown in FIG. 9, the first USB power module 922 connected to the hot swap connection port 916 is a 100 W power module. The second USB power module 924 connected to the hot swap connection port 918 is a 60 W power module. The third USB power module 926 connected to the hot swap connection port 920 is a 30 W module. Each of the USB power modules 922-926 are coupled to a respective USB port 928, 930, 932, and provide their associated rated output to an external device coupled to the respective USB ports 928, 930, 932. In some embodiments, the USB power modules 922-926 may be limited where the total power of the USB power modules 922-926 exceeds the total power budget of the hub device 900. For example, the hub device 900 may have a total power budget of 200 W, and therefore no derating or limiting of the USB power modules 922-926 is required as the total output power of the three USB power modules is 190 W.

Turning now to FIG. 10, the hub device 900 is shown in a second configuration where the third USB power module 926 has been removed and replaced with a fourth USB power module 934. In one embodiment, the fourth USB power module 934 is rated for 100 W, taking the total requested output power to 260 W when combined with the first USB power module 922 (100 W) and the second USB power module 924 (60 W). Where the total power of the USB power modules 922, 924, 934 exceeds the total power budget of the hub device 900 (e.g., 200 W), the USB power modules 922, 924, 934 may be derated/limited. As shown in FIG. 10, the USB power modules 922, 924, 934 are derated to approximately 77% of their full rated output thereby reducing the total output to 200 W, in line with the total power budget of the hub device 900.

In some embodiments, the USB power modules 922, 924, 934 may self derate/limit based on receiving a total power budget of the hub device 900. For example, the controller 910 may be in communication with the USB power modules 922, 924, 934 via the hot swap connection ports 916-920. In other examples, the power source 902 may provide the total power budget to the USB power modules 922, 924, 934. In other embodiments, the controller 910 may be configured to control the output of the various USB power modules 922, 924, 934 to limit their respective rated outputs based on the total power budget of the hub device 900.

Thus, embodiments described herein provide, among other things, a configurable charging device. Various features and advantages are set forth in the following claims.

What is claimed is:

1. A power output device, comprising:
a plurality of output ports;
a power source; and
a controller configured to:
receive a user input indicating a desired configuration of the plurality of output ports; and
configure the plurality of output ports based on the received user input and a total power budget of the power output device.

2. The power output device of claim 1, wherein the received user input specifies a desired output power for each of the plurality of output ports.

3. The power output device of claim 2, further comprising:
a power matrix circuit coupled to the controller, and wherein the controller is further configured to control the power matrix circuit to provide the desired output power to each of the plurality of output ports.

4. The power output device of claim 1, further comprising:
a port manager configured to receive one or more device parameters associated with one or more external devices coupled to the plurality of output ports.

5. The power output device of claim 4, wherein the controller is further configured to configure the plurality of output ports based on the received one or more device parameters associated with the one or more external devices coupled to the plurality of output ports.

6. The power output device of claim 5, wherein the received user input includes one or more device priority profiles, the one or more device priority profiles configured to identify an output power priority for each of the plurality of output ports based on the one or more device parameters associated with the one or more external devices coupled to the plurality of output ports.

7. The power output device of claim 1, wherein the plurality of output ports are selected from a group consisting of USB-A ports and USB-C ports.

8. The power output device of claim 1, wherein the power source is a rechargeable power tool battery pack.

9. A method for controlling a multi-output universal serial bus (“USB”) hub device, comprising:
receiving, at a controller of the USB hub device, a user input indicating a desired configuration of one or more output ports of the USB hub device;
determining a total power budget of the USB hub device; and
configuring the one or more output ports of the USB hub device based on the received user input and the determined total power budget,
wherein configuring the one or more output ports includes controlling an available output power for each of the one or more output ports.

10. The method of claim 9, wherein the user input is wirelessly received from an external device.

11. The method of claim 9, wherein the user input is received at a user interface of the USB hub device.

12. The method of claim 9, further comprising:
controlling, using a power matrix circuit of the USB hub device, an amount of available power for each of the one or more output ports based on an instruction from the controller.

13. The method of claim 9, further comprising:
receiving one or more device parameters from one or more external devices coupled to the one or more output ports.

14. The method of claim 13, wherein the one or more device parameters include one or more of a charging voltage of the one or more external devices, an optimal charging power of the one or more external devices, and an identifier of the one or more external device.

15. The method of claim 14, wherein:
the received user input includes a device priority profile; and
the device priority profile prioritizes devices connected to the one or more output ports based on the one or more device parameters.

16. The method of claim 15, further comprising:
controlling the one or more output ports based on the determined total power budget, the received user input, and the one or more received device parameters.

17. The method of claim 9, wherein the one or more output ports are selected from a group consisting of USB-A ports and USB-C ports.

18. The method of claim 9, wherein the USB hub device is powered by a rechargeable power tool battery pack.

19. A modular universal serial bus (“USB”) hub comprising:
a power source;
one or more hot-swappable connection ports; and
one or more USB power modules, each of the one or more USB power modules configured to be connected to the one or more hot-swappable connection ports, the one or more USB power modules each including a USB output port;
wherein each of the one or more USB power modules receives power from the power source and has a power rating that controls an output power available at the respective USB output port.

20. The modular USB hub of claim 19, further comprising:
a controller configured to derate the output power of each of the one or more USB power modules based on a total power budget of the modular USB hub being exceeded.
